(19) United States
(12) Patent Application Publication
(10) Pub. No.: US 2026/0338030 A1
(43) Pub. Date: Oct. 29, 2026

(54) Gasket Seal For Use In Residential Structure Windows

(71) Applicant: Earl Senchuk, Marquette, MI (US)

(72) Inventor: Earl Senchuk, Marquette, MI (US)

(21) Appl. No.: 19/731,964

(22) Filed: Jul. 6, 2026

Related U.S. Application Data
(63) Continuation-in-part of application No. 18/196,421, filed on May 11, 2023, now Pat. No. 12,687,065.
(60) Provisional application No. 63/340,919, filed on May 11, 2022.
(60) Provisional application No. 64/008,300, filed on Mar. 17, 2026.

(51) Int. Cl. E06B 3/62

(52) U.S. Cl. CPC E06B 3/62; E06B 2003/6223; E06B 2003/6244; E06B 2003/6258

(57) ABSTRACT

A gasket is configured for use around a perimeter of a window insert including two long and two short sidewalls. The gasket includes two elongated gasket strips including a first profile shape including a height to width ratio of at least 1:1 and not more than 2:1, each configured to fit along a respective one of the two long sidewalls. The gasket further includes a first additional gasket strip, a second profile shape including a height to width ratio of at least 1:1 and not more than 2:1 configured to fit along a first and top of the two short sidewalls and a second additional gasket strip including a third profile shape including a height to width ratio of at least 1:1 and not more than 2:1 configured to fit along a second and bottom of the short sidewalls. The strips are constructed with crushed ethylene propylene diene monomer.

### CROSS-REFERENCE TO RELATED APPLICATIONS

The subject patent application is a continuation-in-part of co-pending U.S. patent application Ser. No. 18/196,421 filed on May 11, 2023, which claims priority to and all the benefits of U.S. Provisional Patent Application No. 63/340,919, filed on May 11, 2022, and claims priority to and all the benefits of U.S. Provisional Patent Application No. 64/008,300, filed on Mar. 17, 2026, the entire contents of which are incorporated by reference herein.

### FIELD OF THE DISCLOSURE

The invention relates generally to twin-wall/double-pane window inserts, and more particularly to window inserts that are buildable from a kit.

### BACKGROUND

Window inserts are currently available on the market. These window inserts typically come preassembled and require skilled window frame measurement skills by the user and often volunteer labor to install. What is needed are good quality, energy conserving, sound dampening, easy to build window insert kits that have small package footprints and have a wide measuring error tolerance that makes their use extremely simple for the common homeowner to build and install.

A window insert includes a solid frame, providing structure to the window insert and providing a framework for at least one film to be stretched or supported over. This frame is fit within a pocket created around the window. In one embodiment, a top of the pocket may be defined by a head jamb running horizontally above the window, two window jambs running vertically along sides of the window, and a window sill running horizontally along a bottom of the window.

A window insert may act like an extra window pane for the window, trapping a layer of air between the window and the window insert. This trapped layer of air acts as an insulator, decreasing a heat transfer coefficient for the window and correspondingly reducing an amount of heat that flows through the window.

A gasket may be used around a perimeter of a window insert. Such a gasket may be compressible and the window insert frame may be sized such that the gasket may be squeezed between the window insert frame and the pocket of the window. Such a squeezed gasket may partially or fully seal the air between the window insert and the window, preventing air from circulating into and out of the trapped pocket of air. Further, the squeezed gasket may provide a frictional force, preventing the window insert from falling out of the pocket of the window. Further, the gasket may account for variability, warpage, or imperfect window pocket surfaces. Further, such a gasket may accommodate placement of the window insert within an imperfect or irregular window frame, for example, accounting for frames including bow-in, bow-out, out-of-square parallelograms, trapezoids, mismeasurement, and textured surfaces.

### SUMMARY

According to one exemplary embodiment, a gasket configured for use around a perimeter of a window insert including two long sidewalls and two short sidewalls is provided and includes two elongated gasket strips including a first profile shape including a height to width ratio of at least 1:1 and not more than 2:1, each configured to fit along a respective one of the two long sidewalls. The gasket further includes a first additional elongated gasket strip, a second profile shape including a height to width ratio of at least 1:1 and not more than 2:1 configured to fit along a first and top of the two short sidewalls and a second additional elongated gasket strip including a third profile shape including a height to width ratio of at least 1:1 and not more than 2:1 configured to fit along a second and bottom of the two short sidewalls. The gasket strips are constructed with crushed ethylene propylene diene monomer (EPDM) material.

In some embodiments, the first profile shape includes a height to width ratio of 4:3.

In some embodiments, the first profile shape includes a height of one inch and a width of ¾ inches.

In some embodiments, the second profile shape includes a height to width ratio of 4:3.

In some embodiments, the second profile shape includes a height of one inch and a width of ¾ inches.

In some embodiments, the third profile shape includes a height to width ratio of 4:3.

In some embodiments, the third profile shape includes a height of one inch and a width of ¾ inches.

In some embodiments, the first profile shape includes a height to width ratio of 4:3, the second profile shape includes a height to width ratio of 4:3.

According to one alternative embodiment, a window insert assembly is provided and includes an inner frame including two long sidewalls and two short sidewalls and defining an outer perimeter of the inner frame, a first plastic wrap covering a first planar side of the inner frame, and a second plastic wrap covering a second planar side of the inner frame. The window insert assembly further includes an outer frame assembly including a plurality of U-channel outer frame members installed to the outer perimeter of the inner frame and encapsulating ends of the first plastic wrap and second plastic wrap upon the inner frame, the outer frame assembly defining a perimeter of outer flat surfaces extending around an entirety of the outer frame assembly. The window insert assembly further includes a gasket affixed to the outer flat surfaces and extending around the entirety of the outer frame assembly. The gasket includes two elongated gasket strips including a first profile shape including a height to width ratio of at least 1:1 and not more than 2:1, each fitting the outer frame assembly along a respective one of the two long sidewalls, a first additional elongated gasket strip, a second profile shape including a height to width ratio of at least 1:1 and not more than 2:1 fitting the outer frame assembly along a first and top of the two short sidewalls, and a second additional elongated gasket strip including a third profile shape including a height to width ratio of at least 1:1 and not more than 2:1 fitting the outer frame assembly along a second and bottom of the two short sidewalls. The gasket strips are constructed with crushed ethylene propylene diene monomer (EPDM) material.

In some embodiments, each of the first profile shape, the second profile shape, and the third profile shape includes a height to width ratio of 4:3.

In some embodiments, each of the first profile shape, the second profile shape, and the third profile shape includes a height of one inch and a width of ¾ inches.

In some embodiments, the window insert assembly further includes a heat shield film attached to the first plastic wrap.

In some embodiments, the first plastic wrap includes a heat shield film.

In some embodiments, the inner frame is constructed with laminated wood planks.

In some embodiments, the inner frame is constructed with wood planks. The first plastic wrap and the second plastic wrap collectively hermetically seal the inner frame within the window insert assembly to provide warpage resistance of the inner frame.

According to one alternative embodiment, a kit configured for creating a window insert assembly is provided and includes wooden planks configured for creating an inner frame including two long sidewalls and two short sidewalls and, once created, defining an outer perimeter of the inner frame, a first plastic wrap configured for covering a first planar side of the inner frame, and a second plastic wrap configured for covering a second planar side of the inner frame. The kit further includes an outer frame assembly including a plurality of U-channel outer frame members configured for being installed to the outer perimeter of the inner frame and encapsulating ends of the first plastic wrap and second plastic wrap upon the inner frame. The outer frame assembly, once created, defines a perimeter of outer flat surfaces extending around an entirety of the outer frame assembly. The kit further includes a gasket configured for being affixed to the outer flat surfaces and extending around the entirety of the outer frame assembly. The gasket includes two elongated gasket strips including a first profile shape including a height to width ratio of at least 1:1 and not more than 2:1, each fitting the outer frame assembly along a respective one of the two long sidewalls, a first additional elongated gasket strip, a second profile shape including a height to width ratio of at least 1:1 and not more than 2:1 fitting the outer frame assembly along a first and top of the two short sidewalls, and a second additional elongated gasket strip including a third profile shape including a height to width ratio of at least 1:1 and not more than 2:1 fitting the outer frame assembly along a second and bottom of the two short sidewalls. The gasket strips are constructed with crushed ethylene propylene diene monomer (EPDM) material.

### BRIEF DESCRIPTION OF THE DRAWINGS

The disclosure is pointed out with particularity in the claims. The above and further features and benefits of this disclosure are understood by the following Detailed Description taken in conjunction with the accompanying drawings. Unless otherwise stated, the relative dimensions of the components of as illustrated the drawings are generally understood to be the relative dimensions of the components to each other. In the accompanying drawings:

FIG. 1 illustrates a perspective view of a window insert assembly, in accordance with the present disclosure.

FIG. 2 illustrates a partially exploded perspective view of the outer frame assembly of the window insert assembly of FIG. 1, in accordance with the present disclosure.

FIG. 3 illustrates an exploded perspective view of the inner frame assembly of the window insert assembly of FIG. 1, in accordance with the present disclosure.

FIG. 4 illustrates a perspective view of a short plank utilized to construct the inner frame of the window insert assembly of FIG. 1, in accordance with the present disclosure.

FIG. 5 illustrates a perspective view of a long plank utilized to construct the inner frame of the window insert assembly of FIG. 1, in accordance with the present disclosure.

FIG. 6 illustrates an exploded perspective view of a gasket frame utilized to construct the window insert assembly of FIG. 1, in accordance with the present disclosure.

FIG. 7 illustrates an exploded perspective view of an outer frame assembly utilized to construct the window insert assembly of FIG. 1, in accordance with the present disclosure.

FIG. 8A illustrates an end view of an outer frame member utilized to construct the window insert assembly of FIG. 1, in accordance with the present disclosure.

FIG. 8B illustrates an end view of the outer frame member with a gasket and a plank housed within an inner channel and gasket channel of the outer frame member of FIG. 8A, in accordance with the present disclosure.

FIG. 9 illustrates a perspective view of a short plank utilized to construct an inner frame of a window insert assembly, in accordance with the present disclosure.

FIG. 10 is a graphic depicting parts that may be included in a window insert kit, in accordance with the present disclosure.

FIG. 11 is a graphic depicting one method of constructing a window insert assembly and installing the window insert into a window well, in accordance with the present disclosure.

FIG. 12 is a simplified graphic depicting a cross-section of a portion of a low-cost window insert assembly (plastic wraps and tapes removed), in accordance with the present disclosure.

FIG. 13 illustrates an exploded perspective view of a section of a low-cost window insert assembly, in accordance with the present disclosure.

FIG. 14 illustrates a perspective view of an outer frame assembly of U-channel used in a low-cost window insert assembly, in accordance with the present disclosure.

FIG. 15 illustrates a sectional view of a portion of a low-cost window insert assembly through a plane perpendicular to the window insert assembly, in accordance with the present disclosure.

FIG. 16 illustrates a sectional view of a portion of a low-cost window insert assembly through a plane perpendicular to the window insert assembly, in accordance with the present disclosure.

FIG. 17 illustrates a partial perspective view of facing shield that may be used to cover gasket material in a window insert assembly, in accordance with the present disclosure.

FIG. 18 is a simplified graphic depicting a cross-section through a plane perpendicular to the window insert assembly of a window insert assembly having a ribbed T-shaped stiffener, in accordance with the present disclosure.

FIG. 19 illustrates a partially exploded perspective cross-sectional view of a window insert assembly having a ribbed T-shaped stiffener, in accordance with the present disclosure.

FIG. 20 is a simplified graphic depicting a cross-section through a plane perpendicular to the window insert assembly of a window insert assembly having a T-shaped stiffener, in accordance with the present disclosure.

FIG. 21 illustrates a partial cross-sectional view of a window insert assembly having a T-shaped stiffener, in accordance with the present disclosure.

FIG. 22 illustrates an exploded perspective view of a window insert assembly having a T-shaped stiffeners in the outer frame assembly, in accordance with the present disclosure.

FIG. 23 is a partial perspective view of a member of the inner frame (plank) having a stiffener groove along both a long side and short side, in accordance with the present disclosure.

FIG. 24 is a graphic depicting the method of constructing a window insert assembly for a window using T-shaped stiffeners, in accordance with the present disclosure.

FIG. 25 schematically illustrates in side view an exemplary gasket adhered to a member of a window insert assembly, in accordance with the present disclosure.

FIG. 26 schematically illustrates in side view the gasket of FIG. 25 in preparation for being adhered to the member, in accordance with the present disclosure.

FIG. 27 schematically illustrates in top-down view a window pocket including a window pane, window jamb, and a window casing, the jamb and casing collectively defining a reveal, and further including a window insert assembly of FIGS. 12-16, in accordance with the present disclosure.

FIG. 28 schematically illustrates in front view the window insert assembly of FIG. 27 installed to the window pocket, in accordance with the present disclosure.

### DETAILED DESCRIPTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

Disclosed herein are a variety of embodiments of a window insert assembly. In some forms, the window insert assembly is easy to assemble from a window insert kit, in other forms, the insert assembly is pre-assembled. Window inserts are useful to improve insulation or increase a heat transfer coefficient across an exterior window. As a result of installing a window insert, when it is colder outside than inside the structure, less heat will escape the structure.

Disclosed herein are a variety of embodiments of a window insert assembly 100. In some forms, the window insert assembly 100 is easy to assemble from a window insert kit 101, in other forms, the insert assembly is pre-assembled.

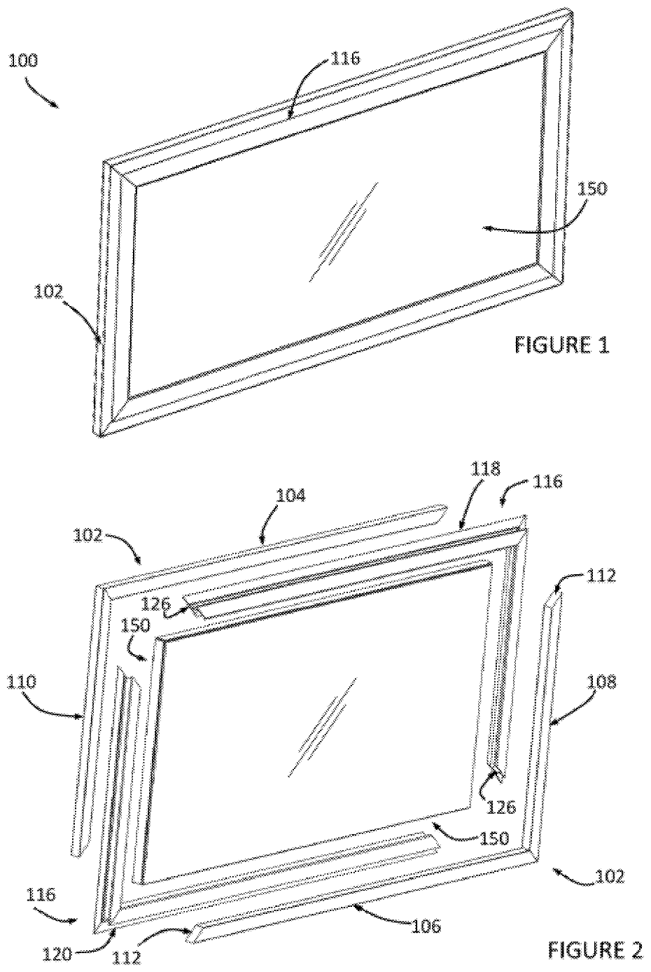

As illustrated in FIGS. 1-2, the window insert assembly 100 comprises an outer frame assembly 116, a gasket frame 102, and an inner frame assembly 150. The outer frame assembly 116 is made from an assembly of a first outer frame long member 118, a second outer frame long member 120, a first outer frame short member 122, and a second outer frame short member 124. As illustrated in FIG. 8, the individual outer frame members have a cross-sectional profile defining an inner channel 129 and a gasket channel 130 separated by a common wall 128. As illustrated in the embodiment, the inner channel 129 is substantially U-shaped whereas the gasket channel 130 is substantially J-shaped whereby the outer frame member may be described as having a J-U shaped profile. The channels of the J-U profile open in opposite directions as further depicted in FIG. 8. The U-shaped inner channel 129 is defined by the common wall 128 at the base of the U, and defined by an opposed first flange 138 and second flange 140 extending from the common wall base. Further noted in the Figure, the first flange 138 and second flange 140 are toed inwards 142. The toed in first flange 138 and second flange 140 are deflected outwards (FIG. 8B) when a plank (such as second short plank 160B) from an inner frame 152 is seated within inner channel 129. The plastic wrap and the two-way tape are not shown in FIG. 8B. FIG. 8B also illustrates a gasket (such as first short gasket 108) seated in the gasket channel 130. With this arrangement, it is clear that the gasket may be compressed as needed to assist the window insert to fit within a window frame despite small errors in measurement.

The J-shaped gasket channel 130 is defined by the common wall 128 and a long flange 132 and a short flange 134 extending from each side of the common wall 128. The gasket channel 130 comprises a pair of opposed in-steps 136 protruding into the gasket channel 130 and whereby the in-steps are spaced in parallel relation from the common wall 128. One or more edges of the J-U profile have a tapered corner 144.

As noted in FIG. 7, members of the outer frame assembly 116 are cut to a predetermined length and have ends mitered at 45 degrees whereby the members may be assembled at their mitered ends 126 in an operable configuration into an open square or rectangle. In this operable configuration, the gasket channel 130 faces outwards and the inner channel 129 faces inwards.

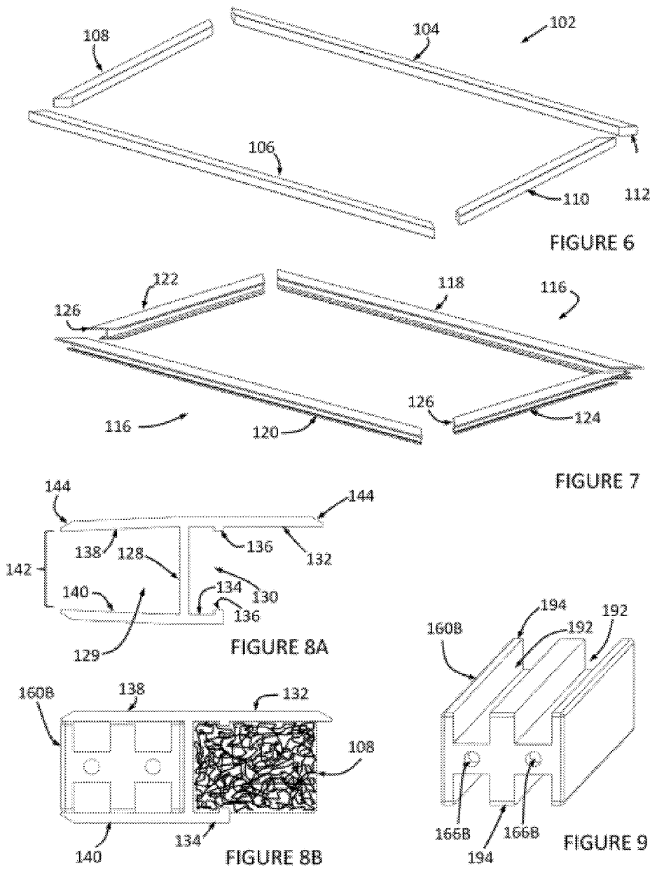

The window insert assembly 100 comprises a gasket frame 102 as noted in FIG. 6. The gasket frame 102 comprises a pair of long gasket members (first long gasket 104 and second long gasket 106) and a pair of short gasket members (first short gasket 108 and second short gasket 110). The gasket members are elongate foam members having a square or rectangular cross-section although other cross-sections such as circular or elliptical could also be effective. In some embodiments, the gasket members have gasket mitres 112 (45 degrees) such that the gasket member forms a rectangle or square like a picture frame. In alternative embodiments, the gasket member ends are cut at 90 degrees and assembled into a similar square or rectangle. Adhesives may be used to bond ends of gasket members together.

The gasket members are seated within the gasket channels 130 of complementing outer frame members and thereby encircle an assembled outer frame assembly in an operable configuration. When a gasket is placed in the gasket channel 130, a good portion of the gasket (0.5-0.75 inch) is exposed on one side. Therefore, when a homeowner's window frame is measured, there may be a rather broad tolerance for error and still have the window insert fit snugly within the window frame since the gasket may be compressed to various degrees and will make up for these measurement issues. The gasket members (first long gasket 104, second long gasket 106, first short gasket 108, and second short gasket 110) are held in position in the gasket channels by a pair of opposing in-steps 136 protruding into the gasket channels and squeezing gasket that is pushed into the channel. If the gasket is prepared with a peel-and-stick adhesive, and in-steps 136 and short flange 134 are not needed, then all of the gasket is exposed on one side. See FIGS. 8A and 8B.

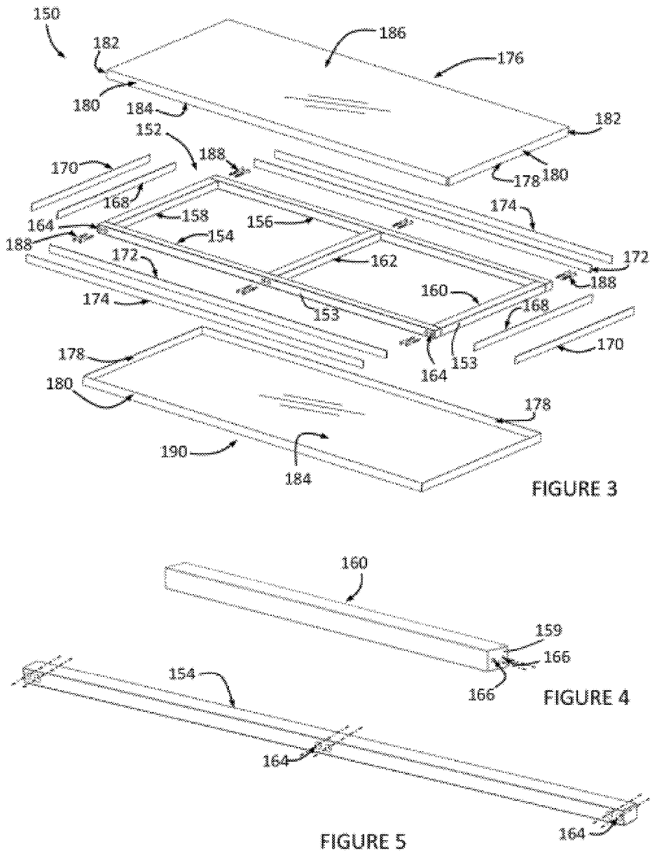

The inner frame assembly 150 of FIG. 3 comprises an inner frame 152. The inner frame is constructed of an assembly of long planks (first long plank 154, second long plank 156) and short planks (first short plank 158, second short plank 160). In some embodiments, the long and short planks and the center brace 162 are of equal length.

As noted in FIG. 3, the long planks and short planks are secured to each other using screws 188 that are driven across the joints between aligned pre-formed holes 164 and guide holes 166. In some forms, one or two parallel spaced screws (i.e. flathead screws, cabinet screws) are utilized to secure each junction between the long and short planks. The long planks and short planks are arranged to form a rectangular or square frame when secured by fasteners. Counter sunk or counter bored pre-formed holes 164 extend through the planks and are aligned with guide holes 166 that extend at least partially into the planks. The pre-formed holes 164 and the guide holes 166 are aligned for quick assembly using screws between the short planks and long planks.

The inner frame 152 comprises a first long plank 154, a second long plank 156, a first short plank 158, a second short plank 160, and an optional third short plank 162 if additional structural support is needed intermediately in the inner frame 152 between the first short plank and second short plank. A first short dual sided tape 168 and a first long dual sided tape 172 are adhered on respective long plank and short plank outside perimeter surfaces of the inner frame 15. A first plastic wrap 176 is placed over the inner frame 152 with an inner adhesion face 178 stuck to the first short dual sided tape 168 and first long dual sided tape strips 172. Excess first plastic wrap 176 is then trimmed away whereas one side of the inner frame is covered by the first plastic wrap 176.

A second short dual sided tape 170 and a second long dual sided tape 174 are then adhered on respective outer adhesion faces 180 of the first plastic wrap 176. A second plastic wrap 190 is placed over the opposite side of the inner frame 152 with an inner adhesion face 178 stuck to the second short dual sided tape 170 and second long dual sided tape 174. Excess plastic wrap is then trimmed away whereas the opposing side of the inner frame 152 is covered by the second plastic wrap 190. Strips of weatherization tape, for example, selected to be compatible with the materials involved, may be used to enclose exposed first and/or second plastic wrap at the corners of the inner frame after trimming corners 182. The tape that is used to encapsulate the plastic wrap 176, 190 may be selected based on the tape and adhesive thereupon being compatible with the adhesive used to join the gasket 108 to the rest of the window insert assembly 100.

The short planks and long planks are manufactured of wood or a polymer which includes recycled polymers. In some embodiments, the short planks and long planks have a generally square or rectangular cross-sectional profile. In some embodiments such as illustrated in FIG. 9, the short plank and/or long planks comprise one or more elongate channels 192 extending along the outer surface of the long and short planks on opposing sides. The elongate channels define the formation of ribs 194 extending from one end to an opposing end of the short and long planks. The elongate channels 192 are covered when the short planks or long planks are fully seated in the inner channel of the outer frame long or short members.

A heat gun is used in some methods to heat one or more of the first plastic wrap 176 and second plastic wrap 190 causing consequent removal of wrinkles and thereby improving visual clarity and sound reduction of the window insert assembly 100. The inner frame assembly 150 is seated in the inner channel 129 of the outer frame assembly 116 such that the outer frame assembly bounds the inner frame assembly 150 on all sides.

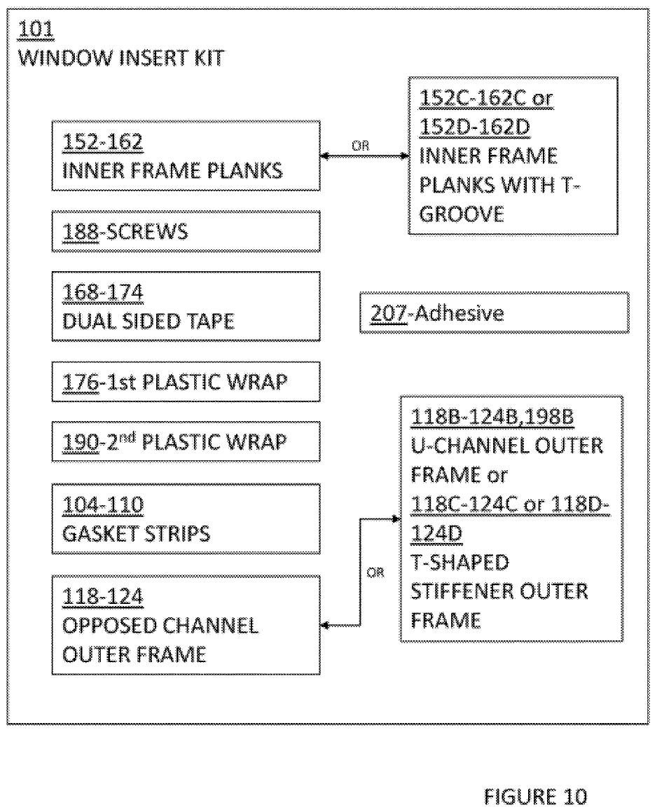

As depicted in FIG. 10, the window insert assembly 100 is provided as a window insert kit 101. The window insert kit 101 comprises: adhesive 270, inner frame planks 152-162, screws 188, dual sided tape 168-174, a first plastic wrap 176, and an optional second plastic wrap 190 all for constructing the inner frame assembly 150.

The window insert kit 101 also comprises: outer frame long and short members 118-124 which has opposed channels to build the outer frame, and gasket strips 104-110 to construct the gasket fame 102. In some embodiments, the window insert kit may include scissors or similar cutting device operable for trimming plastic wrap and/or a heat gun. In some embodiments, window insert kit 101 can comprise alternative components depending on the type of inner frame planks (with or without T-groove), and depending on the type of outer frame members (J-U profile, U-channel or metal foil, T-shaped). These alternatives are depicted in FIG. 10 and discussed further below.

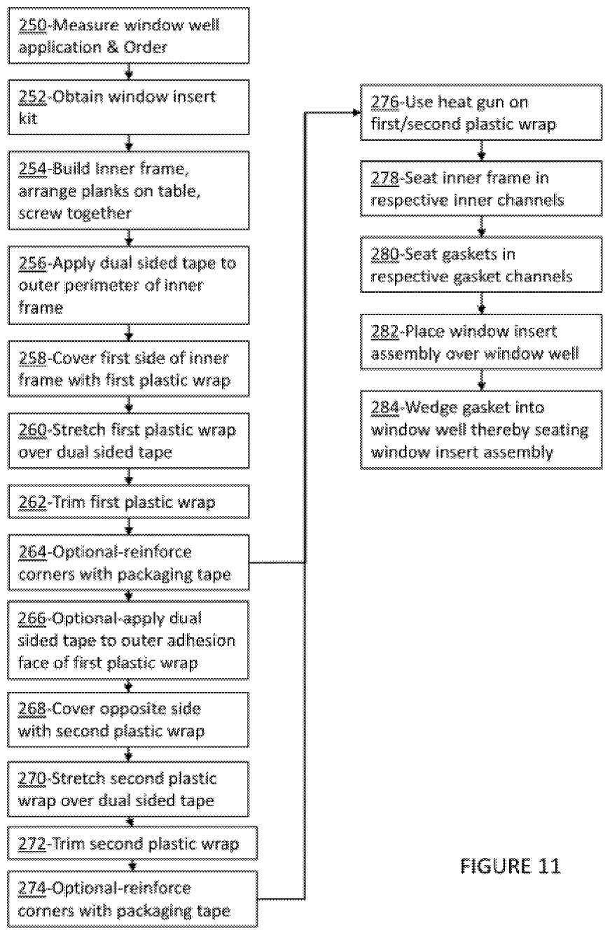

FIG. 11 illustrates steps in a process for assembling a window insert assembly 100 from a window insert kit 101 consistent with the embodiment of FIGS. 1 and 2. In a first step, a user measures the interior size of the indoor facing window frame and places an order for the appropriately sized window insert assembly (250). The correct size window insert kit is obtained (252) either from a store's inventory or mail order. The user then builds the inner frame (254) by arranging the short planks and long planks on a table to obtain the proper size inner frame 152, aligning the preformed holes 164 with the guide holes 166, and driving the screws to secure the planks together whereby the screw heads are seated in the counter-sunk/counter bored holes. The user then applies the dual sided tape to the four outer perimeter 153 surfaces of the inner frame 152 (step 256) leaving one side of the tape exposed. A first side of the inner frame 152 is then covered with the first plastic wrap 176 (step 258), and the first plastic wrap is stretched over the exposed dual sided tape (260). The excess first plastic wrap is then trimmed (262). As an option, the trimmed corners are reinforced with packaging tape (264). Also as an optional step, a second side of the inner frame 152 is covered with a second plastic wrap 190 and includes additional steps. Dual sided tape is applied to the outer adhesion face 180 of the first plastic wrap (266). The second side of the inner frame 152 is then covered with a second plastic wrap (268) and the second plastic wrap is stretched over the exposed dual sided tape (270). Excess second plastic wrap is then trimmed away (272). The exposed corners of the inner frame may be then reinforced with packaging tape if so desired (274). The user then proceeds to use a heat gun on the first and second (if present) plastic wrap (276) to remove wrinkles in the plastic wraps, improve clarity, and reduce noise. The inner frame is then seated in the respective inner channels 129 of the respective outer frame members (278). The gaskets are then seated in the gasket channels 130 of the respective outer frames (280), however, in some embodiments, the gaskets may be pre-seated in the outer frame members at the factory. The assembled window insert assembly 100 is then placed over the indoors facing window frame (282), and each gasket is wedged into the window frame/well using a tool such as a plastic spatula as needed as the window insert assembly 100 is fully seated in the window frame (284). This technique may be modified as needed for minor differences in the outer frame assembly.

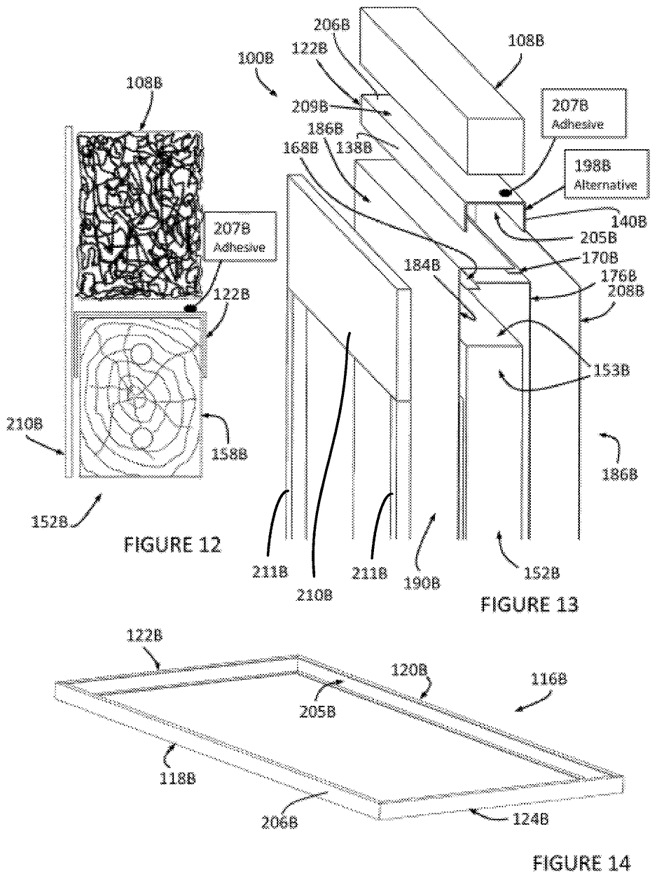

FIGS. 12-16 depict an embodiment of a low-cost window insert assembly 100B. This window insert assembly comprises an inner frame 152B that is substantially the same as the inner frame 152 of the FIG. 3 embodiment. As before, inner frame 152B is assembled to be planar from a first long plank, a second long plank, a first short plank 158B, a second short plank 160B and an optional third short plank and secured by screws 188 through pre-formed holes 164, however other fasteners and/or adhesives can also be used.

Like the FIG. 3 embodiment, one broad side of the inner frame 152B of the low-cost window insert assembly 100B is covered with a first plastic wrap 176B which may be in the form of a polyolefin heat shrink film. The first plastic wrap 176B is cut to fully cover the broad side of the inner frame 152B and cover the outer perimeter 153B of the inner frame 152B using a length of dual side tape (i.e. a first short dual side tape 168B or a first long dual side tape 172B respectively) therebetween. Upon folding over the outer perimeter, plastic wrap extending beyond the outer perimeter 153B of the inner frame 152B may be trimmed away.

As further depicted in FIG. 13, the opposing broad side of the inner frame 152B of the low-cost window insert assembly 100B is covered with a second plastic wrap 190B which may be in the form of a polyolefin heat shrink film. The second plastic wrap is cut to fully cover the broad side of the inner frame 152B and cover the outer perimeter 153B of the inner frame using a dual side tape (i.e. a second short dual side tape 170B or a second long dual side tape 174B respectively) between the first plastic wrap 176B and the second plastic wrap 190B. Plastic wrap extending beyond the outer perimeter 153B of the inner frame 152B may be trimmed away. FIG. 13 further illustrates a short facing shield 210B and two long facing shields 211B.

In this embodiment, the low-cost window insert assembly 100B comprises an outer frame assembly 116B constructed of a series of U-channel outer frame members of plastic or metal that are pressed over the outer perimeter 153B of the inner frame 152B thereby encapsulating the ends of the first plastic wrap 176B and second plastic wrap 190B within the capture space 205B of the U-channel.

FIG. 14 illustrates the outer frame assembly 116B which comprises first outer frame long member 118B, second outer frame long member 120B, first outer frame short member 122B, and second outer frame short member 124B. An adhesion face 206B on the outer base 209B of the U-channel is utilized to adhere gasket material using an adhesive 207B. Adhesive 207B may be applied manually during installation or may be pre-applied to the gasket material with a peel-and-stick adhesive configuration. It will be appreciated that adhesive 207B may be applied to gasket 108B, outer base 209B, or both.

A plurality of elongate gaskets having a generally square or rectangular profile are secured directly to the adhesive face 206B of the outer frame members (i.e. U-channel or adhesive backed metal foil). This positioning of all four gaskets is depicted in the FIGS. 1 and 2 embodiments with the exception that the J-U shaped outer frame members that are depicted in FIGS. 1 and 2 are replaced with the U-channel members depicted in FIG. 14.

In some embodiments, the elongate gaskets have a thickness of approximately 1.125″ and are compressible to approximately 0.125″. They can also have a width of approximately 0.75″. The elongate gasket is preferably: UV tolerant, weatherable, has a relaxed pace memory, is closed cell (for insulation value and sound dampening), has good sound dampening and sealing qualities, may be secured to itself using adhesives, and is compatible with paints over time. It should also be noted that a heat shield film may be applied over top of the outdoors facing plastic wrap to block UV light.

As noted in FIG. 13, as an alternative to the elongate U-channels, the low-cost window insert assembly 100B comprises an adhesive backed metal foil 198B that is applied over the outer perimeter of the inner frame adhered directly to the exposed surface of the second plastic wrap 190B and a portion of the broad faces of the first plastic wrap 176B and second plastic wrap 190B. Although not rigid like the U-channel, it assumes a U-channel shape and it serves the purpose of encapsulating the inner frame and plastic wrap. The outer face of the encapsulating tape, whether aluminum or plastic, may include excellent compatibility with the gasket adhesive.

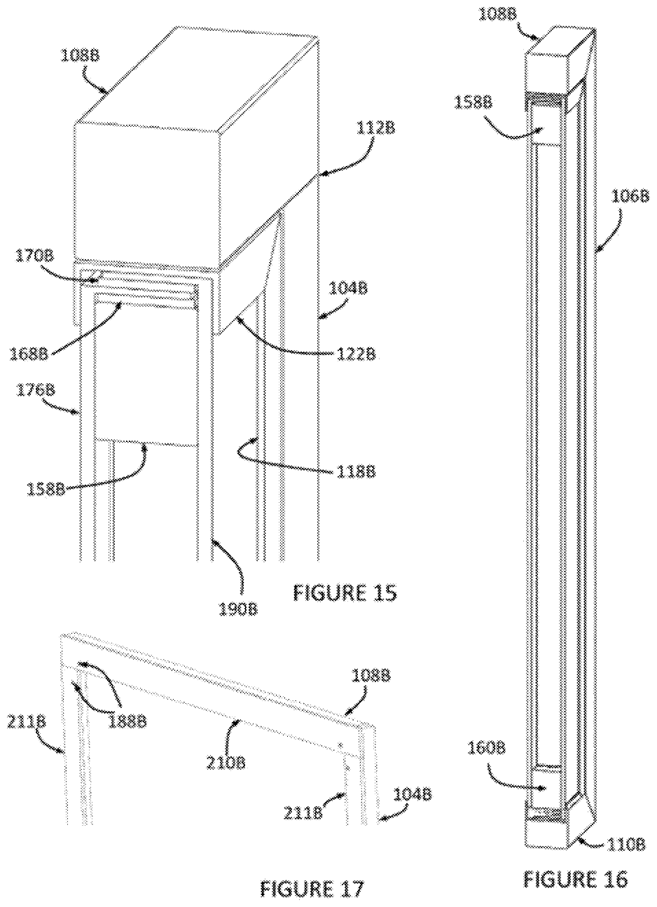

Referring to FIG. 15, the gasket 108B is illustrated joined at a squarely cut junction 112B. This is one optional way to join the portion of the gasket 108B that runs vertically to the portion of gasket 108B that runs horizontally. Another way would be to have both of the gaskets 108B diagonally cut and joined along the diagonal surfaces.

FIG. 17 illustrates various facing shields of varying lengths that may be utilized over portions of the window insert assembly. In one form the facing shield is in the form of an elongate wood or polymer decorative trim having a generally rectangular cross-section. The facing shields may be sized for the required length as noted in the Figure whereas a single window insert can include pairs of short facing shields 210B, and long facing shields 211B. The facing shields may be secured to the inner frame 152 B using screws 188B, tape, or other adhesives. The facing shield may be applied to the low-cost window insert bridging between a building's window frame and the inner frame of the low-cost window insert thereby covering the gaskets from view.

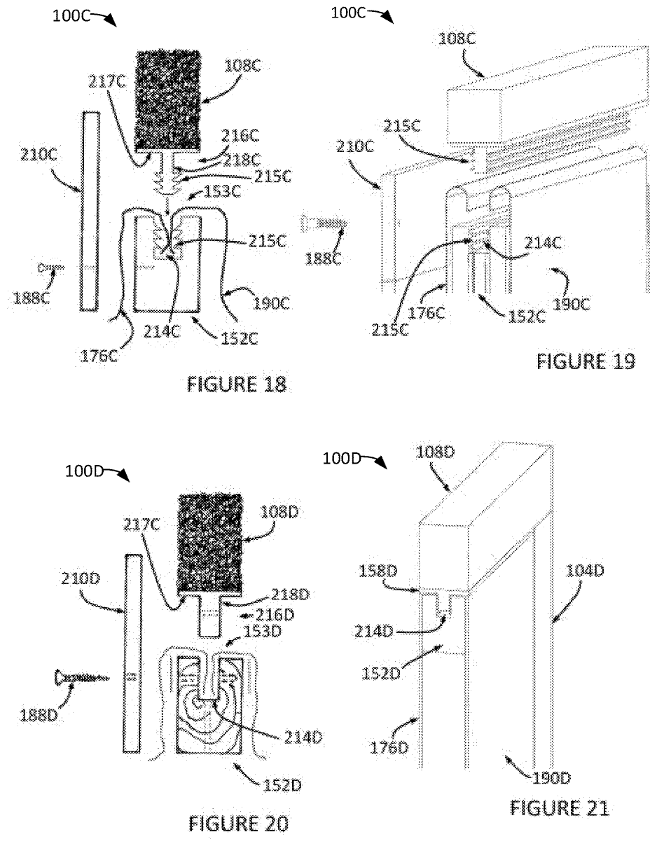

FIGS. 18-19 depict yet another embodiment of construction of a window insert 100C to minimize warping of the inner frame and to speed assembly. In this embodiment, the outer perimeter 153C of the planks of the inner frame 152C comprise a stiffener groove 214C configured to receive the stiffener leg 218C that extends perpendicular from the stiffener base 217C of outer frame long member and short members and are otherwise in the form of a T-shaped stiffener 216C. Here the inside angle of the stiffener head abuts the outer perimeter when the stiffener leg 218C is fully inserted. Stiffener ribs extend from one or more of the stiffener leg 218C and stiffener groove 214C and interlock when the T-shaped stiffener is inserted into the stiffener groove but can slide out when the window is disassembled. A gasket such as first short gasket 108C is then secured to the exposed T top of the stiffener base 217C using an adhesive or adhesive tape (in some embodiments, the gaskets are pre-adhered to the stiffener base at the factory). FIG. 20-21 illustrates a window insert assembly 100D that is essentially the same as the embodiment of FIG. 18-19, however, the stiffener leg 218D and/or stiffener groove 214D is absent stiffener ribs. The ribbed version is conducive for manufacture from an extruded metal such as aluminum, vinyl, recycled ocean plastic, extruded hemp, or other polymer, whereas the embodiments without ribs are easily manufactured from woods as well as the materials just listed.

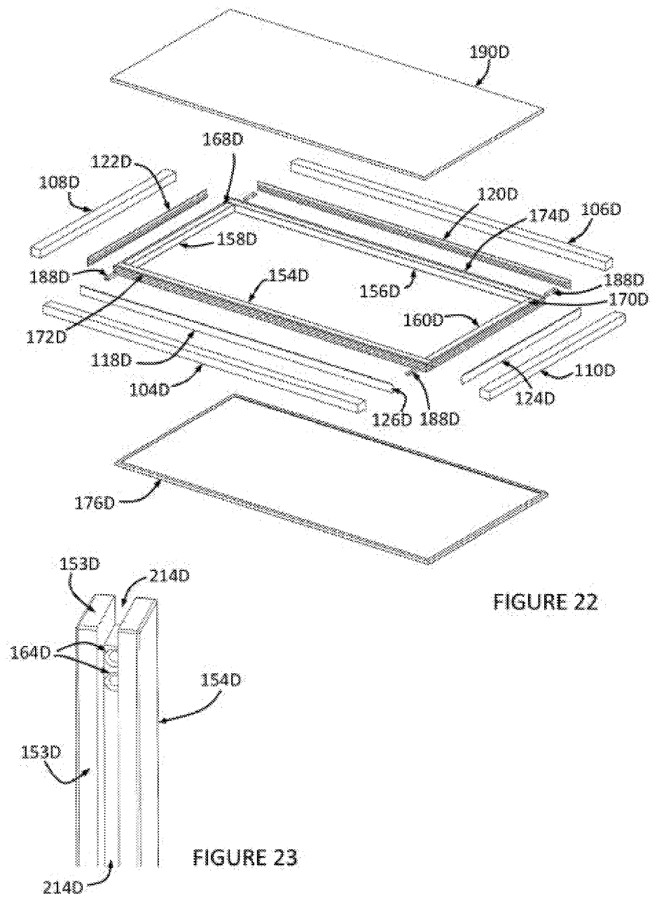

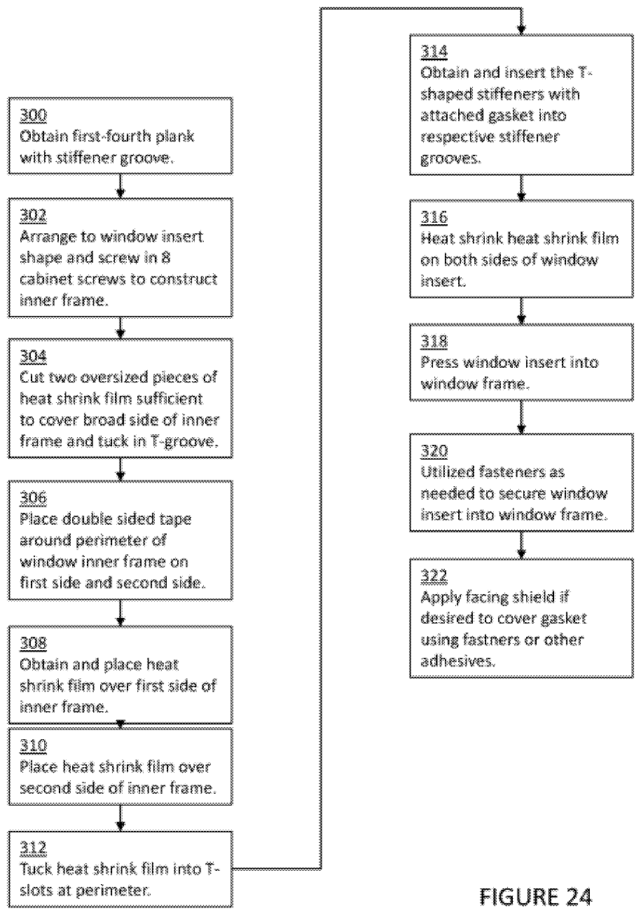

FIG. 22 illustrates an exploded view of the window insert assembly 100D and also represents window insert assembly 100C with the exception that the Figure is absent of stiffener ribs 215C. It should be noted that a third short plank as depicted in FIG. 3 can also be used in the FIG. 22 embodiment. Two fasteners 188D are depicted at each junction, however, in some embodiments only one fastener is utilized. FIG. 23 illustrates one end of a first long plank 154D. Note that stiffener groove 214D is inset into the center of outer perimeter 153D along both the long and short sides, whereas the stiffener groove is inset only into the long sides of the outer perimeter on the short planks.

It should be noted that different techniques may be used to join the elongate members. Although select embodiments herein may depict joining elongate members by mitered end, or by an end-to-side construction, embodiments of the disclosed invention are not limited to one technique or the other.

One embodiment of a method for assembling a window insert with a T-shaped stiffener 216C, 216D comprises the steps of: obtaining a first long plank, a second long plank, a first short plank, a second short plank and optionally a third short plank wherein each plank comprises an elongate stiffener groove. Arranging the planks to form an inner frame of the desired window insert profile whereby the stiffener groove is continuous about the outer perimeter of the inner frame (300). Arrange planks into window insert shape and advance screws through pre-formed holes in the planks thereby forming a secure inner frame (302). Cut two oversized pieces of heat shrink film sufficient to cover broad side of inner frame and tuck into the plank's T-groove (304). Placing a double sided tape on the front facing and rear facing surfaces of the planks (306). Obtaining and stretching a first plastic wrap across the broad side of the window and adhering it to the double-sided tape while leaving a perimeter portion of the first plastic wrap available for tucking into the adjacent stiffener groove (308). Obtaining and stretching a second plastic wrap across the broad side of the inner frame and adhering it to the double-sided tape while leaving a perimeter portion of the second plastic wrap available for tucking into the adjacent stiffener groove (310). Tucking the perimeter portion of the first and second plastic wrap into the stiffener groove (312). Obtaining a plurality of T-shaped stiffeners with a gasket adhered to the T top of the T-shaped stiffener and advancing the T-shaped stiffeners into the respective stiffener grooves (314). Applying heat to the heat shrink film on both sides of the window insert (316). Aligning and pressing the window insert into the window frame (318). Obtaining and utilizing fasteners as needed to secure the window insert in the window frame (320). Applying a facing shield if desired to cover exposed gasket (322). It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Referring again to FIGS. 12-16, an embodiment of a low-cost window insert assembly 100B is illustrated. A number of alternative films or coatings may be provided upon the plastic wrap, and may be included on one or both plastic wraps. In one embodiment, the film may be entirely decorative, providing a color or visual pattern upon the plastic wrap. Such a decorative pattern may be a modest tint or evenly applied color film, such as light blue, light yellow, or rose colored. In another embodiment, a pattern of butterflies, falling leaves, sailboats, or snowflakes may be printed upon the plastic wrap. Commercial or popular trademarks may be licensed and printed upon the wrap as a decorative theme. In another embodiment, a functional film such as a heat shield film may be applied over top the outdoors facing plastic wrap to block UV light. In another embodiment, a translucent or opaque pattern may be printed upon the wrap, partially or fully obscuring direct view through the plastic wrap may be provided. In one embodiment, the pattern may be an entirely black film to obscure sight through the plastic wrap. In a similar embodiment, a pattern that looks like closed shades or drapes may be printed upon the plastic wrap. Similarly, the decorative trim including the short facing shield 210B and long facing shields 211B may include decorative patterns or color schemes to enhance the visual appearance of the window insert assembly 100B after it is installed. For example, a palette of alternative wood grain patterns may be available to match the wood grain pattern on the window casings (e.g., oak, maple, cherry, poplar, pine, etc. ; particular stain or paint colors, etc.) to which the window insert assembly 100B is being installed.

As is illustrated in FIGS. 15 and 16, gasket 108B surrounds a window insert and provides for a compressive seal around the window insert within the window pocket in which the window insert is installed. The dimensions and properties of the gasket 108B affect the performance of the gasket 108B, the seal created by the gasket 108B, the properties of the installed window insert, and the ease of installation and the experience of the user in installing the window insert. Dimensions are important to all of these results. For example, if a gasket is too thin, meaning that the surface which is adhered to the window insert is too thin, the compression force provided by the compressed gasket may be too small and the resulting adhesion of the gasket to the window insert may be too slight and the gasket may roll or become dislodged from the sides of the window insert. Such rolling or dislodging of the gasket 108B may cause the gasket 108 to leak or become difficult to install, uninstall, or reinstall. If a gasket 108B is too wide, it may overhang the window insert edges, may be too difficult to compress, may store enough compressive gasket force to cause the window insert to later dislodge from the window pocket, or may increase to excess difficulty in installing or uninstalling the window insert. Further, width of the gasket 108B may be limited by a width of the matching surface upon the window pocket. For example, wooden panels trimming a window opening may be ½ inch or ¾ inch thick. Seating the window insert to the window pocket may optimally include matching a width of the gasket 108B to a thickness of the trim around the window pocket, in an area known in the art as a reveal, thereby matching the window insert to pre-existing surfaces of the window pocket.

Height of the gasket 108B may be defined as the distance that the outer edge of the gasket extends outwardly in the direction parallel to the flat sides of the plastic wrap or in the direction parallel to the flat face of the window pane being covered. The height of the gasket 108B as a value in isolation of the width of the gasket 108B is important in determining how much the gasket 108B is compressed. The outer frame assembly 116B of FIGS. 12-16 may be sized, i.e., the height and width of the frame assembly 116B without the gasket 108B yet in place as it fits within the window pocket may be selected, based on the size of the window pocket in which the window insert will be installed. The outer frame assembly 116B will rest its entire weight upon the gasket 108B along the bottom edge of the outer frame assembly 116B. This portion of gasket 108B along the bottom edge may be additionally compressed by the weight of the assembly 116B. The portions of gasket 108B along the sides and top of the assembly 116B may be compressed to a desired compression level, for example, to a compression ⅜ of the uncompressed height of the gasket 108B. This desired compression level or the height of the gasket 108B at a desired compression is a function of the material utilized to construct the gasket 108B. The desired compression of the gasket 108B may provide excellent retention of the window insert within the window pocket and may account for any irregularity between the surface of the window pocket. Over-compression of the gasket 108B may result in the window insert being too difficult to install or uninstall or may result in damage to the gasket 108B. Under-compression of the gasket 108B may result in the window insert falling out of the window pocket after installation or may result in air leakage around the gasket. Such air leakage may cause issues such as excessive condensation build-up between the window insert and the window pane being covered by the window insert. The height of the outer frame assembly 116B, the components of the window insert without the gasket 108B yet installed, may be described in one example by the following Equation 1:

H_{Assembly}=H_{WindowPocket}−(H_{Gasket Compressed by Weight of Insert}+H_{Gasket at Desired Compression}) (1)

In some instances, the compression of the gasket resulting from the weight of the insert over or in addition to the desired compression of the gasket may be negligible. Similarly, a width of the outer frame assembly 116B, the components of the window insert without the gasket 108B yet installed, may in one example be described by the following Equation 2:

W_{Assembly}=W_{WindowPocket}—(2×H_{Gasket at Desired Compression}) (2)

In this way, given a window pocket that a window insert is to be installed to and a given or desired seal 108B configuration, the dimensions of the outer frame assembly 116B may be selected and the length of the components thereto may be configured, sized, cut to length, etc.

The width of gasket 108B may be important to the operation and installation of the described window insert. The height of the gasket 108B may be important to the operation and installation of the described window insert. The ratio of the height of the gasket 108B to the width of the gasket 108B may also be important to the operation and installation of the described window insert. When an architect is designing a load-bearing column, a slenderness ratio may be accounted for to prevent such a load-bearing column from buckling. The selections of height and width of gasket 108B may similarly observe a desirable or operational range of height to width ratio values. In one embodiment, a desirable range of height to width ratio values may be between 1:1 or 1.0 to 2:1 or 2.0. In one embodiment, a desirable height to width ratio may be described as 4:3 or 4/3 (i.e., one and a third.)

In some embodiments, the gaskets 108B have a thickness of approximately 1 inch and also have a width of approximately 0.75 inch. The gasket is preferably ultraviolet tolerant, weatherable, has a relaxed pace memory, is constructed with either semi-closed cell foam or closed cell foam (for insulation value and sound dampening), has good sound dampening and sealing qualities, may be secured to itself or another similar gasket using adhesives, and is compatible with paints over time. Semi-closed cell foam includes an advantage that some minimal air transfer is permitted through the seal. In this way, minor changes to atmospheric pressure, wind pressure upon the window being covered, temperature, and other factors may not result in the plastic wrap of the window insert bowing in or bowing out excessively.

The disclosed inserts may be applied permanently or may be removable for storage in an off-season, for example, in moderate weather when frequent opening of the window is desirable. As described herein, the window insert may be configured or include selected size and material properties to make the window insert installable and un-installable for repeated reuse.

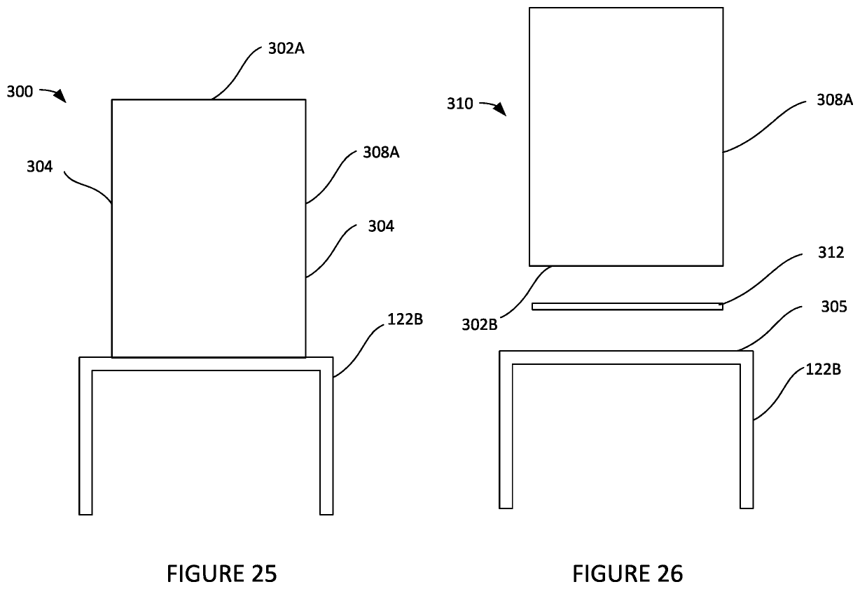

FIGS. 25 and 26 illustrate an exemplary embodiment of a gasket that may be utilized in accordance with the window inserts described herein. Configuration 300 is illustrated. The first outer frame short member 122B is illustrated as a component that may be positioned or disposed around a perimeter of a window insert. The first outer frame short member 122B has an outer flat surface 305 which, with a plurality of first outer frame members, may run about an entire perimeter of the window insert. A plurality of alternative outer flat surfaces resulting from different window insert constructions are envisioned. Such an outer flat surface, combined with the other outer flat surfaces of the window insert, may be sized, selected, configured, or configurable to match a window frame or a pocket within which a window frame may fit. In particular, the outer flat surfaces of the window insert may be configured to be some size, for example, ½ inch smaller on all sides than the pocket in which the window insert is desired to be fit. The gasket 308A is illustrated adhered to the outer flat surface 305. The gasket 308A may be compressible so as to fit within and, when moderately or somewhat compressed, apply some amount of compressive force against both the outer flat surface and the pocket to which the window insert is fit. This compressive force results from the gasket 308A being compressed or squeezed between the pocket surface and the window insert, such that a dimension of a side wall 304 of the gasket is reduced when the window insert is installed. This compression of the gasket 308A may be beneficial from a standpoint of providing friction to hold the window insert in place within the pocket and further to seal air between the window insert and the window frame that was already installed to the pocket. In this way, the window insert may be fit within the pocket, be retained within the pocket, and may substantially trap air between the window insert and the window frame, thereby creating an insulative layer of air.

The window insert may substantially seal the insulative layer of air between the window insert and the window frame. However, if the seal is too effective, pressure differences over time may cause issues with the plastic film of the window insert. For example, if direct sunlight hits the insulative layer between the window insert and the window frame, the air within that layer may expand and cause increased pressure within the layer as compared with atmospheric pressure within the interior room adjacent to the window insert. This pressure difference may cause the film to bow outwardly, which may be unsightly and interfere with operation of a window blind or shade, may cause the window insert to pop out of the pocket, or may even cause a rupture or hole to form in the plastic film of the insert, for example, if it fell out of the window pocket against a sharp edged object. Similarly, a strong wind pressing against the window pane within the window frame may cause increased pressure within the insulative layer, similarly causing the plastic film of the window insert to bow. Such effects of pressure changes in the insulative layer may be mitigated or lessened by using a porous or breathable gasket material within the gasket 308A. The semi-permeable nature of the gasket allows the pressure to be released over a large or relatively larger surface area. An example of such a porous gasket material may include crushed EPDM (Ethylene Propylene Diene Monomer). An example of such a crushed EPDM may be purchased as Ensolite EFO through Armacell located at 55 Vilcom Center Drive Suite 200, Chapel Hill, North Carolina, USA, 27514. Other breathable gasket materials may be utilized to a similar result.

The gasket 308A may come in a variety of shapes and sizes. In one exemplary configuration, the gasket 308A around the entire perimeter may include a gasket with a height to width ratio of between 1.0 and 2.0. In another exemplary configuration, the gasket 308A around the entire perimeter may include a gasket with a height to width ratio of 4:3. In another exemplary configuration, the gasket 308A around the entire perimeter may include a gasket with a height of 1 inch and a width of ¾ inch. In another exemplary configuration, the gasket 308A may include the sidewalls 304 at 1 inch in length and top and bottom walls (302A and 302B, respectively) at ¾ inch in length, with a rectangular profile in cross-section, as illustrated in FIG. 6. Such a shape and size may be advantageous. For example, the width of the first outer frame short member 122B (provided as an example of the illustrated members 118B, 120B, 122B, 124B of FIGS. 12-16) is illustrated at an exemplary width of 1 inch. The width of member 122B may in other embodiments be ¾ of an inch. Having the width of the gasket bottom wall 302B be ¾ of an inch provides for the gasket to fit on either width of the member 122B.

Although the gasket may be compressed from an exemplary initial height of 1.125 inches down to an entirely compressed height of ⅛ inches, such extreme compression may not be workable for installing the gasket into the window pocket. Tightly packing the gasket into such a small space can result in permanent deformation of the gasket. The gasket may in one embodiment be compressed down to not more than an exemplary ⅜ inches to allow full rebound to its original dimensions to enable reuse in the next season.

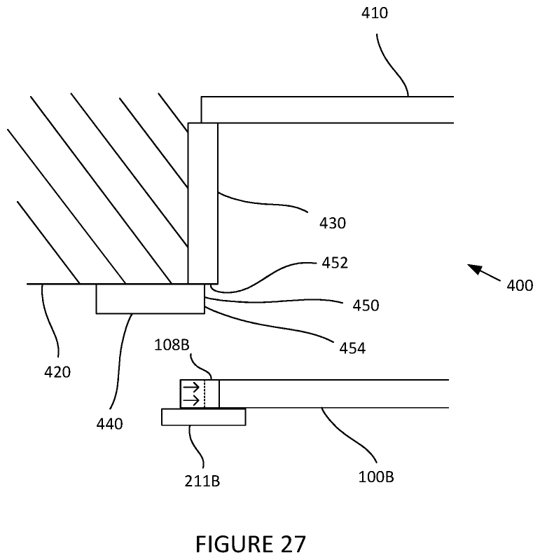

FIG. 27 is a top-down illustration of a window pocket 400 including a window pane 410, a window jamb 430, and a window casing 440, the jamb 430 and casing 440 collectively defining a reveal 450, and further including the window insert assembly 100B. The window insert assembly 100B is illustrated in an uninstalled state, ready to be installed to the window pocket 400. The jamb 430 and the casing 440 are each installed to a wall 420. The jamb 430 and the casing 440 are offset, which creates an angular recess between the jamb 430 and the casing 440 which defines a reveal 450. The reveal 450 includes a first surface 452 parallel to the window pane 410 and a second surface 454 perpendicular to the window pane 410. When window insert assembly 100B including gasket 108B is installed to the window pocket 400, the gasket 108B is compressed (as illustrated by two arrows within the gasket 108B to a compressed position defined by the illustrated broken line within the gasket 108B.) This compression enables the window insert assembly 100B to fit within the reveal 450. By making the width of gasket 108B similar or equal to the width of second surface 454, the window insert assembly 100B may be flush or substantially flush with the front surface of the casing 440 when installed. The gasket 108B may come into sealing contact with both first surface 452 and second surface 454. After installation of the window insert assembly 100B to the window pocket 400, the gasket 108B is compressed between the outer frame assembly of the window insert assembly 100B and the second surface 454, and, additionally, the gasket 108B is flush with and seals against the first surface 452. Further, the contact between first surface 452 and the gasket 108B creates a maximum installation depth for the window insert assembly 100B, maintaining a desired gap space between the window insert assembly 100B and the window pane 410. It will be appreciated that the illustrated window insert assembly may further include the decorative trim illustrated in FIG. 13 including short facing shield 210B and two long facing shields 211B. One of the long facing shields 211B is illustrated. Such decorative trim, if installed, would be flush with the external face of casing 440 and with the external/exposed face of the inner frame of the illustrated window insert assembly 100B.

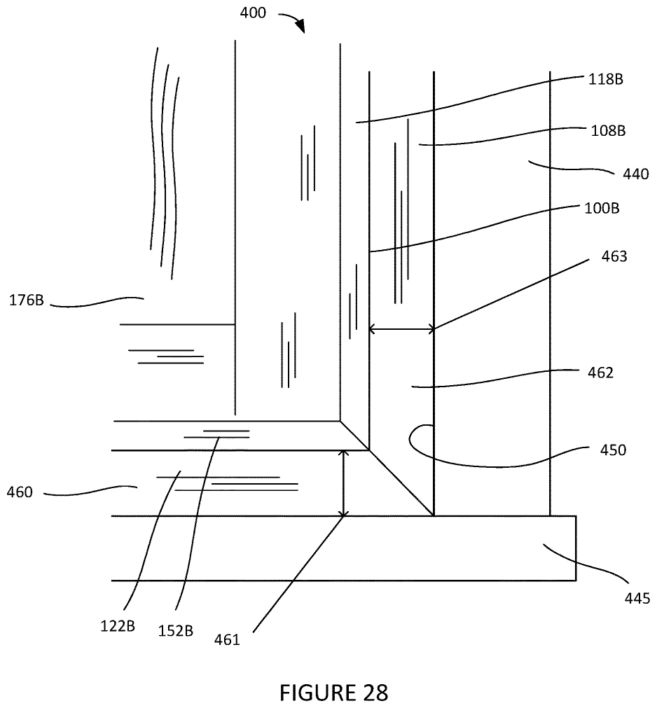

FIG. 28 illustrates the window insert assembly 108B of FIG. 27 installed to window pocket 400. The window insert assembly 100B is illustrated including the inner frame 152B, the first plastic wrap 176B, outer frame long member 118B, outer frame short member 122B, and gasket 108B including a portion 460 along a bottom edge of the window insert assembly 100B and a portion 462 along a side surface of the window insert assembly 100B. The window pocket 400 is illustrated and is partially defined by the casing 440 and a sill 445. The window insert assembly 100B is installed to the reveal 450. The dimensions of the reveal 450 and the dimensions of the window insert assembly 100B are such that the gasket 108 must be compressed in order for the window insert assembly 100B to be installed within the reveal 450. In some embodiments, the portion 460 may be compressed some additional amount, as expressed by dimension 461, than the portion 462, as expressed by the dimension 463, as a result of the weight of the window insert assembly 100B resting upon the portion 460. In other embodiments, such as is illustrated in FIG. 28, the dimension 461 may be substantially equal or equal to the dimension 463. In other embodiments, the dimensions 461, 463 may differ from each other depending upon portions 460, 462 being used to fill variances or mismeasurements of the window pocket 400 which may occur in either the horizontal or vertical directions.

The plastic wrap disclosed herein, such as the plastic wrap 176B and the plastic wrap 190B of FIGS. 12-16 may be constructed with clear plastic sheet material. Additionally or alternatively, a heat shield film may be utilized to achieve desirable thermal properties, for example, rejecting heat in the hot summer months or trapping heat within the structure during winter months. Examples of heat shield film materials include Gila Heat Shield Film available through the company Eastman Performance Films, LLC, 575 Maryville Centre Drive St. Louis, Missouri 63141, United States and BDF NSN70 Window Film Transparent High Heat Rejection & UV Cut film available through the company BuyDecorativeFilm (BDF), 7050 Village Dr, Suite I, Buena Park, California 90621, United States.

Heat shield film may be utilized seasonally. Ultraviolet light converts to infrared energy once it passes through window glass and enters a structure. This conversion may be described as a greenhouse effect. Heat shield film in some implementations acts like a two-way mirror that blocks 99% of ultraviolet light

Heat shield films are frequently provided including a mirror layer and a silicone layer attached to the mirror layer. In known application of the heat shield film to a glass window, the silicone layer may be peeled away and discarded prior to installing the mirror layer to the glass surface. In one exemplary construction of the presently disclosed window insert assembly, the heat shield film may be used in place of the plastic wrap material. In such an application where the heat shield film is attached directly to the inner frame of the window insert assembly, the mirror layer and the silicone layer may be installed to the inner frame (without peeling the silicone backer layer from the mirror layer.) The retained silicone layer provides additional UV protection as compared to simply using the mirror layer by itself.

Such construction of a window insert assembly including a heat shield film may be most useful on west and/or south facing windows to reject UV light during the hottest part of a day. An exemplary method for installing a heat shield film to a window insert assembly 100, 100B, 100C, 100D is provided. First, on a flat surface, lay an assembled do-it-yourself window insert (DIYWI) kit wood frame on top of a rolled-out layer of a heat shield film, mirror side down. With a writing implement, draw an outline around the outer perimeter of the assembled wood frame. Next, one may cut out the outline. Next, one may mark the heat shield film and frame so they go back together the same way later. After this, one may roll up the heat shield film and lay it aside. One may then complete construction of the DIYWI kit assembly process as usual.

For one to temporarily attach the heat shield film to the assembled DIYWI kit, one may attach to a top of an assembled DIYWI kit a three-inch length of removable tape to the outside edge of all four corners just inside the gasket. On a top side of the removable tape on all four corners, one may apply a 2½-inch length of double sided taped keeping the double-sided tape inside the edges of the removable tape. One may then roll out the precut heat shield film, mirror side up. Next, one may attach the heat shield film just as it was laying when it was outlined. Next, one may insert the assembled DIYWI kit as you normally would with the mirror side out on your west and south facing windows in the summertime. In one implementation, in winter, where heat from UV light intrusion and the associated heating is welcome, the heat shield film may be uninstalled and stored for use the following summer.

It may be noted that custom gasket shapes such as are described for use with gasket 108B or gasket 308A may be difficult to form with some blade cutting methods. Such methods tend to create gaskets with hourglass shape profiles. A water jet process may be utilized to cut crushed EPDM material, for example, from an original 1 inch by 1 inch profile to shape to a desired 1 inch by ¾ inch profile shape while maintaining straight sidewalls in the gasket (without creating the hourglass shape.)

The disclosed window insert assembly 100, 100B, 100C, 100D may be provided to consumers as a do-it-yourself kit. A wooden frame such as the inner frame 152 of FIG. 3 or the inner frame 152B of FIG. 13 may be subject to warpage or deformation due to exposure to humidity or other factors. The wooden portions of the window insert assembly 100, 100B, 100C, 100D may be hermetically sealed, for example, within a sealed plastic bag, such that the wood frame elements are protected from warpage until opened by the customer. The customer may be instructed not to open the sealed package until ready to assemble the kit. Once the kit is assembled, the wood may in some embodiments be sealed within the plastic wrap layers and may be protected from humidity unless the film is breached. Alternatively or additionally, the wooden portions of the window insert assembly 100, 100B, 100C, 100D may be laminated to prevent air and associated humidity from warping the wood.

The foregoing disclosure is not intended to be exhaustive or limit the disclosure to any particular form. The terminology which has been used is intended to be in the nature of words of description rather than of limitation. Many modifications and variations are possible in light of the above teachings and the disclosure may be practiced otherwise than as specifically described.

1. A gasket configured for use around a perimeter of a window insert including two long sidewalls and two short sidewalls, comprising:
two elongated gasket strips including a first profile shape including a height to width ratio of at least 1:1 and not more than 2:1, each configured to fit along a respective one of the two long sidewalls;
a first additional elongated gasket strip, a second profile shape including a height to width ratio of at least 1:1 and not more than 2:1 configured to fit along a first and top of the two short sidewalls; and
a second additional elongated gasket strip including a third profile shape including a height to width ratio of at least 1:1 and not more than 2:1 configured to fit along a second and bottom of the two short sidewalls; and
wherein the gasket strips are constructed with crushed ethylene propylene diene monomer (EPDM) material.

2. The gasket of claim 1, wherein the first profile shape includes a height to width ratio of 4:3.

3. The gasket of claim 1, wherein the first profile shape includes a height of one inch and a width of ¾ inches.

4. The gasket of claim 1, wherein the second profile shape includes a height to width ratio of 4:3.

5. The gasket of claim 1, wherein the second profile shape includes a height of one inch and a width of ¾ inches.

6. The gasket of claim 1, wherein the third profile shape includes a height to width ratio of 4:3.

7. The gasket of claim 1, wherein the third profile shape includes a height of one inch and a width of ¾ inches.

8. The gasket of claim 1, wherein the first profile shape includes a height to width ratio of 4:3; and
wherein the second profile shape includes a height to width ratio of 4:3.

9. A window insert assembly comprising:
an inner frame including two long sidewalls and two short sidewalls and defining an outer perimeter of the inner frame;
a first plastic wrap covering a first planar side of the inner frame;
a second plastic wrap covering a second planar side of the inner frame;
an outer frame assembly including a plurality of U-channel outer frame members installed to the outer perimeter of the inner frame and encapsulating ends of the first plastic wrap and second plastic wrap upon the inner frame, the outer frame assembly defining a perimeter of outer flat surfaces extending around an entirety of the outer frame assembly; and
a gasket affixed to the outer flat surfaces and extending around the entirety of the outer frame assembly, the gasket comprising:
two elongated gasket strips including a first profile shape including a height to width ratio of at least 1:1 and not more than 2:1, each fitting the outer frame assembly along a respective one of the two long sidewalls;
a first additional elongated gasket strip, a second profile shape including a height to width ratio of at least 1:1 and not more than 2:1 fitting the outer frame assembly along a first and top of the two short sidewalls; and
a second additional elongated gasket strip including a third profile shape including a height to width ratio of at least 1:1 and not more than 2:1 fitting the outer frame assembly along a second and bottom of the two short sidewalls; and
wherein the gasket strips are constructed with crushed ethylene propylene diene monomer (EPDM) material.

10. The window insert assembly of claim 9, wherein each of the first profile shape, the second profile shape, and the third profile shape includes a height to width ratio of 4:3.

11. The window insert assembly of claim 9, wherein each of the first profile shape, the second profile shape, and the third profile shape includes a height of one inch and a width of ¾ inches.

12. The window insert assembly of claim 9, further comprising a heat shield film attached to the first plastic wrap.

13. The window insert assembly of claim 9, wherein the first plastic wrap includes a heat shield film.

14. The window insert assembly of claim 9, wherein the inner frame is constructed with laminated wood planks.

15. The window insert assembly of claim 9, wherein the inner frame is constructed with wood planks; and
wherein the first plastic wrap and the second plastic wrap collectively hermetically seal the inner frame within the window insert assembly to provide warpage resistance of the inner frame.

16. A kit configured for creating a window insert assembly comprising:
wooden planks configured for creating an inner frame including two long sidewalls and two short sidewalls and, once created, defining an outer perimeter of the inner frame;
a first plastic wrap configured for covering a first planar side of the inner frame;
a second plastic wrap configured for covering a second planar side of the inner frame;
an outer frame assembly including a plurality of U-channel outer frame members configured for being installed to the outer perimeter of the inner frame and encapsulating ends of the first plastic wrap and second plastic wrap upon the inner frame, the outer frame assembly, once created, defining a perimeter of outer flat surfaces extending around an entirety of the outer frame assembly; and
a gasket configured for being affixed to the outer flat surfaces and extending around the entirety of the outer frame assembly, the gasket comprising:
two elongated gasket strips including a first profile shape including a height to width ratio of at least 1:1 and not more than 2:1, each fitting the outer frame assembly along a respective one of the two long sidewalls;
a first additional elongated gasket strip, a second profile shape including a height to width ratio of at least 1:1 and not more than 2:1 fitting the outer frame assembly along a first and top of the two short sidewalls; and
a second additional elongated gasket strip including a third profile shape including a height to width ratio of at least 1:1 and not more than 2:1 fitting the outer frame assembly along a second and bottom of the two short sidewalls; and
wherein the gasket strips are constructed with crushed ethylene propylene diene monomer (EPDM) material.
